(19) United States
(12) Patent Application Publication
(10) Pub. No.: US 2003/0225763 A1
(43) Pub. Date: Dec. 4, 2003

(54) Self-improving system and method for classifying pages on the world wide web

(75) Inventors: Farzin G. Guilak, Beaverton, OR (US); Daniel P. Lulich, Portland, OR (US); Paul Stephen Rehfuss, Seattle, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/413,441

(22) Filed: Apr. 14, 2003

Related U.S. Application Data
(60) Provisional application No. 60/372,772, filed on Apr. 15, 2002.

(51) Int. Cl. G06F 7/00

(52) U.S. Cl. 707/7

(57) ABSTRACT

A self-improving system and method for classifying a plurality of digital documents such as web pages into one or more categories. Textual features and contextual features are extracted from a digital document and submitted to a committee machine. The committee machine assigns a rating to the digital document as a function of the extracted features and provides the location such as a URL for the digital document and its rating to an output data store. The output data store stores a list of locations for the plurality of digital documents. The output data store further segregates the locations of the digital document into categories based on the content of each document as indicated by the assigned rating.

### TECHNICAL FIELD

The present invention relates to the field of document classification. Specifically, the invention relates to the automatic classification of digital documents based on the analysis of both textual and contextual information contained within the digital document.

### BACKGROUND OF THE INVENTION

With the rapid development of the World Wide Web (web), web users can access a tremendous amount of information. To access information relating to a specific topic, web user can submit queries in a process often referred to as “surfing the web” and receive a list documents related to the topic. The returned list of documents is logically and semantically organized as a list of web pages. Unfortunately, web pages covering different topics or different aspects of the same topic are frequently included in the returned list. One way of limiting topics in the returned web pages is by searching document categories using category search systems available on the web. Category search systems review web pages and assign web pages to categories as a function of the web pages relevance to a particular topic. In some cases, category search systems use experts to manually review documents and assign documents to categories. However, manual categorization by experts is costly, subjective, and not scalable with the ever-increasing amount of data available on the Web. An automatic categorization system for categorizing web pages can avoid the constraints of a manual process with human assessors.

Web pages contain text features such as words, phrases, and punctuation marks, and can contain context features such as hyperlinks (links), HTML tags, and metadata. The automatic categorization of web pages typically involves employing a classifier to consider the textual features on a single web page, and to make a decision regarding the content on the web page. This approach can be problematic because many web pages contain little or no textual information. For example, some web pages only consist of images, hyperlinks, or other non-textual data types. As a result, classifiers that only consider text features limit the amount of web pages that can be accurately categorized. Moreover, classifiers that fail to consider neighboring pages, as defined by links or redirects within the page, limit the number documents that can be categorized from a single input.

For these reasons, a self-improving system for categorizing web pages is desired to address one or more of these and other disadvantages.

### SUMMARY OF THE INVENTION

The invention provides a system and method for the automatic categorization of digital documents. In particular, the invention provides a system and method that analyzes both textual and contextual information within digital documents to improve document categorization accuracy and document categorization coverage.

In accordance with one aspect of the invention, a method is provided for categorizing a plurality of documents. The method includes extracting textual and contextual features from within each of the documents. The method also includes identifying untrustworthy documents from the extracted features, and eliminating the untrustworthy documents from documents to be categorized. The method also includes evaluating each of the documents according to one or more of the extracted textual and contextual features. The method also includes identifying lists of documents from the evaluated documents that relate to a topic in response to a user query relating to the topic. The method also includes identifying documents within the identified lists that relate to the topic.

In accordance with another aspect of the invention, a method is provided for categorizing documents. The method includes locating a plurality of documents to be categorized. The method also includes evaluating each of the located plurality of documents. The evaluating includes eliminating pathological pages. The evaluating also includes rating connected documents. The evaluating also includes analyzing links within each of the documents. The evaluating also includes analyzing a file name of each of the documents. The evaluating also includes analyzing names of images within each of the documents. The method also includes indexing the evaluated documents into a plurality of lists in response to a user query relating to a topic. The method also includes identifying lists relating to the topic and identifying documents within the identified lists relating to the topic.

In accordance with another aspect of the invention, a system for categorizing documents is providing. The system includes an input data store for identifying documents to be evaluated. The system also includes a feature extraction tool for extracting page-level information and features from the documents to be evaluated. The system also includes a committee machine for consolidating extracted page-level information and features to decide whether the extracted page-level information and features are trustworthy content. The committee machine is also categorizes documents based on whether the extracted page-level level information and features are trustworthy content. The system also includes an output data store for storing the identification of each of the categorized documents according to their categories.

In accordance with another aspect of the invention, a computer readable medium includes executable instructions for categorizing a plurality of documents. Locating instructions locate the plurality of documents to be evaluated. Extracting instructions extract page-level information and/or features from documents to be evaluated. Examining instructions examine the extracted page-level information and/or features to determine whether the extracted page-level information and/or features are trustworthy content. Categorizing instruction categorize documents according to extracted identified page-level level information and/or features determined to be trustworthy content. Storing instructions store locations of categorized documents according to their categories.

Alternatively, the invention may comprise various other methods and apparatuses. Other features will be in part apparent and in part pointed out hereinafter.

### BRIEF DESCRIPTION OF THE DRAWINGS

FIG. 1 is an exemplary block diagram illustrating one preferred embodiment of components of a classification system for implementing the invention.

FIG. 2 is an exemplary block diagram illustrating one preferred embodiment of components of an extraction tool for extracting features and/or data from documents according to the invention.

FIG. 2A is an exemplary block diagram illustrating the contents of a feature vector created by an extraction tool.

FIG. 3 is an exemplary block diagram illustrating one preferred embodiment of components of the committee machine for analyzing extracted features and/or data, and rating documents according to the invention.

FIG. 4 is an exemplary block diagram illustrating the contents of an output data store according to the invention.

FIG. 5 is an exemplary block diagram illustrating components of a server comprising computer executable instructions for categorizing a plurality of documents according to the invention.

FIG. 6 an exemplary flow chart illustrates a method of categorizing documents according to one exemplary embodiment of the invention.

FIG. 7 is a block diagram illustrating one example of a suitable computing system environment in which the invention may be implemented.

Corresponding reference characters indicate corresponding parts throughout the drawings.

### DETAILED DESCRIPTION OF THE INVENTION

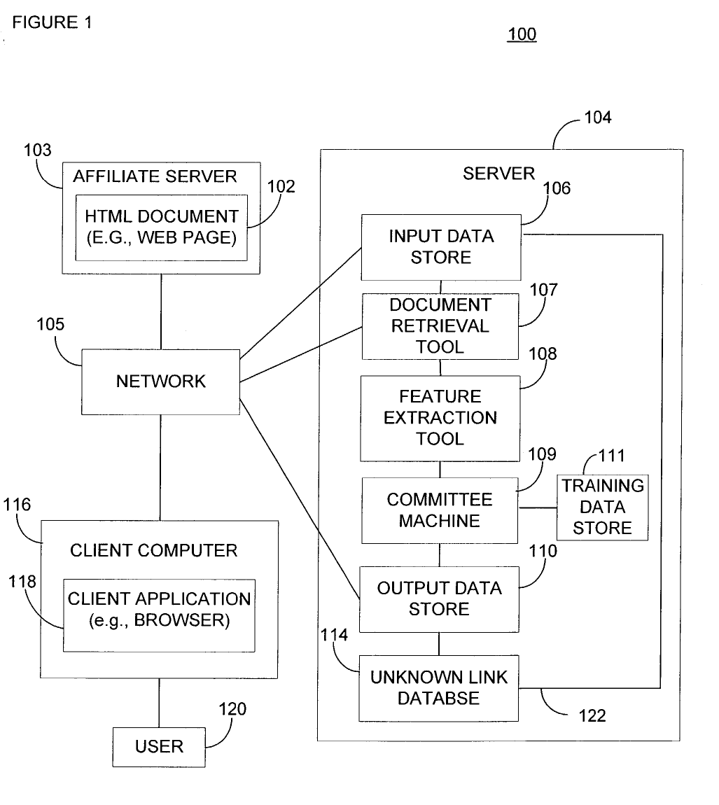

Referring first to FIG. 1, an exemplary block diagram illustrates basic components of a classification system 100 for classifying a plurality of documents 102 according to the invention.

An affiliate server 103 stores or provides access to a plurality of documents 102 such as web pages. Affiliate servers 103 are also referred to as “web servers” or “network servers.” In this instance, as well as to individual web pages, affiliate servers 103 can provide access to commercial repositories of crawled web pages, web sites known to accumulate links relevant to a particular topic, or other databases associated with document classification

A server 104 according to the invention executes a computer program having executing instructions for classifying documents 102. The server 104 is linked to one or more affiliate servers 103 via a communication network 105. In this example, the network 105 is the Internet (or the World Wide Web). However, the present invention can be applied to any data communication network 105. The server 104 and affiliate servers 103 can communicate data among themselves using the hypertext transfer protocol (HTTP), a protocol commonly used on the Internet to exchange information. In this case, the server 104 retrieves documents and/or document information from the affiliate server 108 via the communication network 105, and stores the addresses of the retrieved documents in an input data store 106.

The input data store 106 lists the address of documents 102 to be evaluated by the classification system 100. More specifically, the input data store 106 identifies locations of one or more documents 102 on which the classification system 100 will operate. Although the input data store 106 is shown as a single storage unit within the server 104, it is to be understood that in other embodiments of the invention, the data store may be one or more memories contained within or separate from server 103.

A document retrieval tool 107 retrieves documents 102 using addresses listed in the input data store 106. As known to those skilled in the art, a URL address has a corresponding Internet Protocol (IP) address assigned, for example, by a Domain Name Service (DNS) that provides the unique address of a computer or server on the Internet at a given point in time. By converting the URL to the IP address, retrieval tool 107 retrieves an HTML document 210 such as a web page or web form from the affiliate server 108 via the communication network 105.

A feature extraction tool 108 extracts text features and context features from each of the documents retrieved by the retrieval tool 107. In one embodiment, the feature extraction tool 108 can be a Hyper Text Markup Language (HTML) parser that takes an input HTML file for a web page and outputs a feature list for the page. By extracting text features as well as context features such as links, image text, and URLs, the accuracy and document coverage of the classification system 100 is improved.

A committee machine 109 linked to the feature extraction tool 108 receives and analyzes extracted text and context features. In one embodiment, the committee machine 109 employs one or more learning-based classifiers that determine one or more ratings for the document 102 relative to a selected category or topic such as pornography, and then combines the results to produce an overall classification and/or rating. A variety of learning-based classifiers can be used for rating documents. Examples of such classifiers include, but are not limited to, decision trees, neural networks, Bayesian networks, and support vector machines such as described in the commonly assigned U.S. Pat. No. 6,192,360, the entire disclosure of which is incorporated herein by reference. Notably, the type of classifier used to implement the invention is not as important as the fact that analyzing both textual and contextual features increases the accuracy of the classification system 100.

An output data store 110 linked to the committee machine 109 receives document ratings, and stores document identifiers (e.g., URLs, file names, etc.) along with their corresponding ratings. In one embodiment, the output data store 110 segregates documents 102 into categories (e.g., green list or red list) according to their ratings and a threshold value predetermined by the user 104 or a third party such as the server administrator. The threshold value corresponds to a particular rating value, R_{TH}, determined to be useful in identifying whether a document 102 belongs to a particular category. For example, documents 102 with ratings less than or equal to R_{TH} are identified as not belonging to a particular category. Alternatively, documents 102 with ratings greater than R_{TH} are identified as belonging to the particular category. In one embodiment, a decision tree may be used to determine whether a document 102 belongs to a particular category by applying multiple thresholds and other conditions to the output ratings of multiple classifiers. The committee machine 109 may also identify certain documents as problematic for classification, and which require more resource-intensive operations, such as image classification or human review. The output data store 110 can be linked to the feature extraction tool 108 for comparing extracted feature information with feature information stored in the output data store 110. By comparing target URL information in extracted links to URLs stored in the output data store 110, unknown links can be identified for storage in an unknown link database 114.

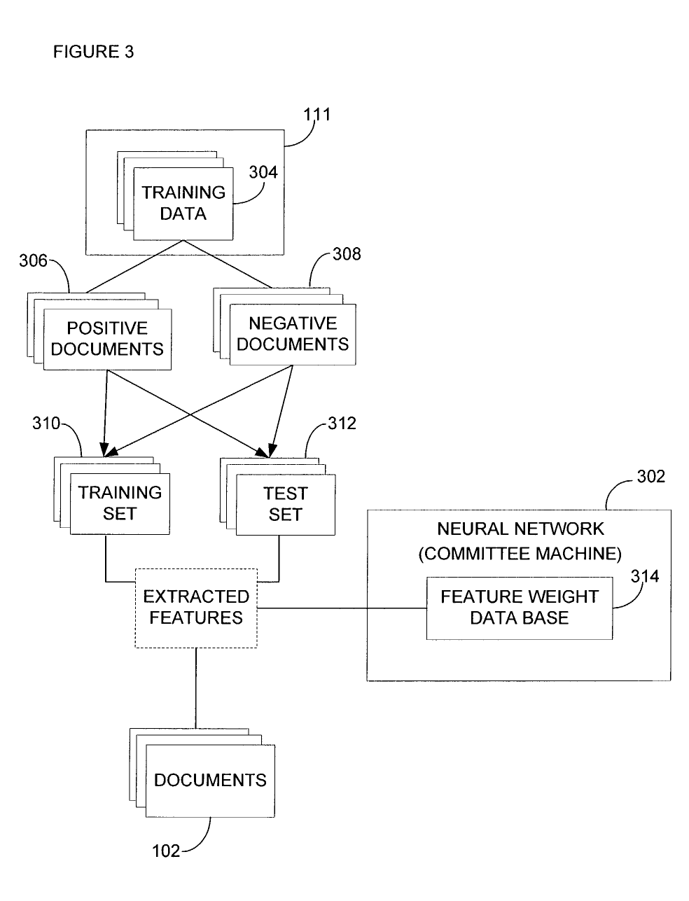

A training data store 111 linked to the committee machine 109 stores training data. As described in more detail below in reference to FIG. 3, training data includes documents 102 that have been determined, either directly by the committee machine 109 or as part of a human review process, to be useful for training of the committee machine 109 or one of its components. For example, documents that have been identified as problematic for classification by the committee machine 109 can be stored in the training data store 111. By directly identifying such training documents with the committee machine 109, the accuracy of the classification system is self-improved.

A client computer 116 can be linked to the network to communicate with the server 104 via a client application 118. As known to those skilled in the art, such client applications 118 are often referred to as web browsers. An example of such client application 118 is Internet Explorer® offered by Microsoft, Inc. In this case, the client computer 116 can retrieve classification information from the output data store 110 via the communication network 105. For example, a user 120 using the client computer 116 can access the output data store via the communication network to determine if a particular web page, as identified by its URL, has been classified. If the URL is known (i.e., previously classified or evaluated) the rating and/or category of the document 102 can be return to the client computer via the communication network. Alternatively, if the URL is not known (i.e., not previously classified) the URL is stored in the unknown link database 114.

In another embodiment, whenever the user 120 employs the client application 118 to retrieve a document 102 from the Internet, the output data 110 store is automatically queried to determine if the document has been rated. Depending on the category or rating, the user 120 can be provided access or denied access to the document 102. Again if the URL is not known (i.e., not previously classified) the URL is stored in the unknown link database 114.

In this embodiment, the unknown link database 114 is linked to the input data store via a feed back path 122 such that, when an unknown URL is stored in the unknown link database 114, the server 103 automatically retrieves the document (i.e., web page) associated with the previously unknown link for classification. By identifying unknown links within documents 102, and automatically retrieving documents for classification, the classification system self improves document 102 coverage.

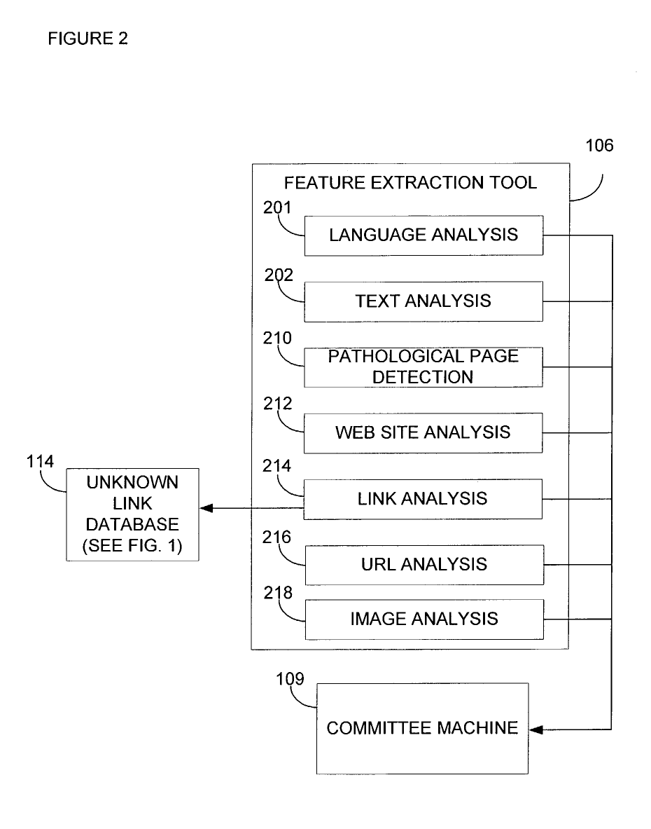

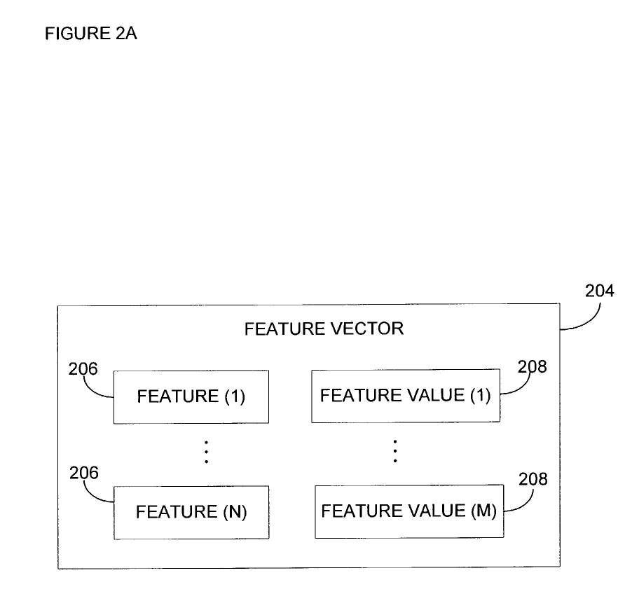

Referring next to FIG. 2, an exemplary block diagram illustrates components of the extraction tool 108 for extracting features from documents 102 such as web pages.

A language analysis component 201 may be used to determine whether documents 102 are in a supported language and language encoding for classification by the classification system 100. If the language analysis component 201 determines a document 102 is in an unsupported language or language encoding, it can be eliminated from the classification process.

A text analysis component 202 parses each textual information object into constituent textual features. Textual features include any textual components, such as words, letters, internal punctuation marks or the like, that are separated from another such component by a blank (white) space or leading (following) punctuation marks. Textual features may also include non-separated (overlapping) entities like contiguous sets of characters of a given length. Syntactic phrases and normalized representations (i.e., regular expressions) for times and dates may also be extracted by the text analysis component 202. In one embodiment, the text analysis component 202 creates a feature vector-representation for each textual component and/or syntactic phrase within the document 102. A feature vector 204 representation for a document 102 is simply a vector of weights for all the features. The weights are based on the frequencies of the features in the document 102.

As shown in FIG. 2A, the feature vector 204 may include feature fields 206 and feature value fields 208. In this case, each of the feature fields 206 correspond to a particular feature such as a word, phase, or attribute extracted from the document 102. The feature value fields 208 correspond to the number of occurrences of each feature. The feature value fields 208 may also correspond to the presence or absence of a feature, rather than its frequency of occurrence. Thus, each feature in the document 102 can be listed in a feature field 206, and the corresponding feature value (i.e., occurrences) can be listed in a feature value field 208. For example, if it is assumed that the document 102 may include words from a 2.5 million-word vocabulary, then the feature vector may include 2.5 million fields each corresponding to a word of the vocabulary. The value stored in the feature value field 208 corresponds to the number of occurrences (i.e., frequency) a particular word of the vocabulary appears in document 102. For instance, if the word “sex” appears in the document five (5) times, then the feature field contains (sex), and the value contained in the feature value field is five (5). Alternatively, the value contained in the feature value field is one (1), which indicates the feature occurs in the document.

Referring again to FIG. 2, a pathological page detection component 210 detects documents that are not amenable to the text classification methods used by the committee machine 109, and eliminates such documents from the classification process. Examples of pathological pages include, but are not limited to, dead sites (e.g., “web page not found” errors), redirects, image only document, documents containing less than a specified amount of text, documents containing unsupported languages, and documents greater than a specified length. Such documents are eliminated from the classification process because the content within such documents is not classified reliably by the committee machine (i.e., untrustworthy). In other words, the content within such documents is unlikely to indicate a particular topic or category.

A web site analysis component 212 collects information regarding the document's web site as a whole to determine an overall rating of the document's web site. For example, the web site analysis component 212 extracts features from as many web pages as possible under the site by following hyperlinks and redirects, and provides the extracted features to the committee machine 109 to determine an overall rating for the entire site. In this case, the overall rating gives an indication of the content distribution within the site. In one embodiment, if the web site is determined to be a host for member sites, the individual member directories are treated as separate sites, because the rating of the top level-hosting site may not translate to some of the lower level member sites. The web site analysis component 212 can also detect dynamic web pages, and eliminate such pages from the classification process. Dynamic web pages are web pages whose content varies based on external factors (e.g., search engines, auction or eCommerce sites, news sites). As a result, precomputed ratings for dynamic web pages are not necessarily trustworthy. For example, the rating for a particular dynamic web page could vary based on the time the user visits the web page, user cookies, and/or search terms.

A link analysis component 214 analyzes the various links available on the web page as defined by the HTML structure to identify, for example, the target web page (i.e., URL). The target web page provides context that can be useful in improving classification accuracy. For instance, since most sites include links to other similar sites, the link analysis component 214 can provide important information as to the category of the web page if the link targets a previously classified web page. For example, if the classification system 100 previously determined (i.e., classified) the target document of the link on the web page as pornography, it is more likely that the web page from which it was extracted is also pornography. In this way, the link analysis component 214 improves efficiency by leveraging existing web page classifications to assist in classifying unknown web pages.

Alternatively, if the document has not been previously classified (i.e., is unknown), the link analysis component 214 provides the link to an unknown link database 213 for storage. The unknown link database 213 can be linked to input data store 104 via the feed back path 122 such that the document retrieval tool 107 automatically retrieves the target documents of each of the links for classification. In one embodiment, such target documents are always retrieved. In alternate embodiments, target document retrieval is optional with the decision to retrieve target documents based on factors such as the rating of the page from which the link was extracted. This automatic feed back of (some) unknown links allows the classification system 100 to continually and automatically self improve document coverage 102.

In another embodiment, the link analysis component 214 can be used to extract terms from a descriptive name associated with the link as defined by the HTML structure to determine the type of content to which the link refers. For example, the use of the term “Sexy” in the descriptive name is likely to indicate that the target points to pornographic content.

A URL analysis component 216 analyzes the URL to determine the category of the URL of the page under consideration, and is especially effective in detection of categories that have highly specific terminology, such as pornography. For example, consider the URL www.xxxporn.com. The URL analysis component 216 analyzes the URL to detect highly specific terminology, such as “porn” which can be used by the committee machine 109 to determine the category of the web page. As a result, the URL analysis component 216 allows sites devoid of text such as image only sites to be categorized. In addition to image-only pages, there are an extremely large number of “parked” sites that fall into this category. Parked sites are URL names that have been registered but currently do not have explicit content, and can go live at any time. Sites that are “Under Construction” or whose server is unavailable when they are pulled can also be classified with this technique.

An image analysis component 218 analyzes various features associated with an image as defined by the HTML structure of the web page to determine a category of the web page. For example, the image analysis component 218 analyzes descriptive text associated with the image to detect highly specific terminology, such as “pornography” which can be used by the committee machine 109 to determine the category of the web page.

Referring next to FIG. 3, an exemplary block diagram illustrates components of the committee machine 109 for analyzing extracted features and/or data, and rating documents according to the invention.

The committee machine 109 is essentially a high level classifier that automatically determines a classification (i.e., rating) for a document based on one or more features extracted from the document. As described above in reference to FIG. 1, a variety of such classifiers can be used to implement the invention. All such classifiers can be described as parameterized functions which take a set of feature values as inputs. The output of the parameterized function may be of various forms, including a single token indicating membership in a category, a single numeric rating, a probability that the document represented by the input features is in a specific class, or a vector of tokens ratings or probabilities as to whether the document belongs to multiple classes. The classifier is parameterized by a set of weights which act to determine the specific input-output behavior of the function. For illustration purposes, the committee machine 109 is described herein as a neural network 302 based classifier. There are essentially two phases in an automatic classification process: a training phase, and a classification phase. During the training phase, training data 304 stored in the training data store 111 is used to develop a list of input features and parameter weights useful in classifying documents relative to specified topics or categories. Typically, the training data 304 consist of a large collection of documents, which have been previously classified, either manually or by a separate classifier, based on their content relative to a specific category. The pre-classified documents include positive 306 documents and negative documents 308. Positive documents 306 are documents that have been determined to belong to a particular category, and negative documents 308 are documents that have been determined not to belong to the particular category.

In order to develop a list of features and weights, the pre-classified documents are split into two document sets: training set 310, and test set 312. Features such as described above in reference to FIG. 2 are extracted from the training set 310, and data (e.g., feature vectors) reflecting the frequency of occurrence of one or more features in each of the documents in the training set 310 is collected. The collected data is statistically analyzed to identify a list of features useful in identifying the particular category (e.g., pornographic or not pornographic) of the pre-classified document. In one embodiment, the list of features is limited to a specified percentage (e.g., 30%) of the most frequent features extracted from the documents belonging to the particular category. A functional form and a set of parameters is chosen by techniques known to those skilled in the art. Each weight in the set of parameters is assigned an initial value, and both the weight and the assigned value are stored in a parameter weight database 314. Initial weighting values stored in the parameter weight database 314 are adjusted by analyzing the test set 312 of training documents. In order to adjust the initial parameter weightings, features are extracted from each document in the test set 312 of training documents and input to the neural-network 302. The neural network 302 evaluates the function determined by the current set of parameter weights on the inputs defined by the features extracted from a given document to produce an output rating for that document. The output ratings are compared to the predetermined designation of each sample document as “positive” or “negative” (e.g., pornographic or not pornographic), and error data is accumulated. The error information accumulated over a large set of training data 304, say 10,000 web pages, is then used to incrementally adjust the initial parameter weightings stored in the parameter weight database 314. The exact adjustment techniques depend on the type of classifier and are known to those skilled in the art. For example, the training data 304 may include 5,000 web pages that are examples of “positive” content (e.g., not pornographic) and another 5,000 web pages that are examples of “negative” content (e.g., pornographic). This process is repeated in an iterative fashion to arrive at a set of feature weightings that are highly predictive of the selected type of content.

During standard operation (i.e., the classification phase), the committee machine 109 evaluates extracted features from documents 102 with the function defined by the parameter weights stored in the parameter weight database 314, without changing the parameter weight values, to determine ratings for documents. After the document 102 receives a rating, it can be classified into a category by comparing the document rating to a predetermined or user specified threshold value. There are various techniques known to those skilled in the art for determining threshold values. For some types of classifiers, e.g. decision trees, the output of the committee machine is already classified into a category and needs no thresholding.

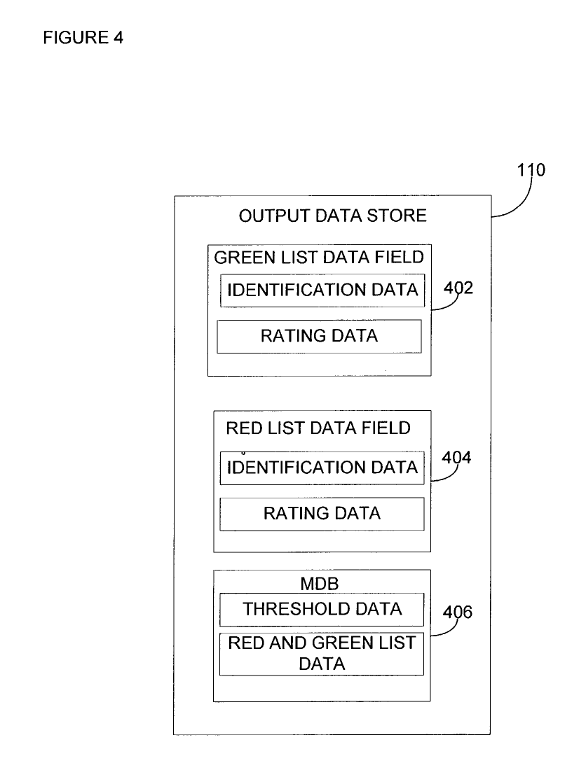

Referring next to FIG. 4, an exemplary block diagram illustrates the contents of an output data store 110 linked to the committee machine 109 for receiving document ratings and storing documents and/or document locations in one or more categories. In one embodiment, the output data store 110 receives document ratings and segregates documents and/or documents locations into categories as a function their rating and a defined threshold value. In this instance, the output data store 110 contains a green list data field 402 and a red list data field 404. As used herein, green list data refers to documents that are not likely to belong to a particular category, and red list data refers to documents that are likely to belong to the particular category.

The green list data field 402 includes green list identification data and green list rating data. The green list identification data includes document location information such as URLs for web pages with ratings less than the defined threshold value, or perhaps directly categorized as belonging to the green list, e.g. by a decision tree committee machine. The green list rating data includes information such as the numerical ratings calculated by the committee machine 109 for each of the documents identified by the green list identification data.

The red list data field 404 includes red list identification data and red list rating data. The red list identification data includes document location information such as URLs for web pages with ratings greater than the threshold value, or perhaps directly categorized as belonging to the red list, e.g. by a decision tree committee machine. The red list rating data includes information such as the numerical ratings calculated by the committee machine 109 for each of the documents identified in the red list identification data.

In one embodiment, the output data store 110 includes a master database (MDB) 406 for storing data such as threshold values for various categories and document location information such as URLs for unknown web pages. The MDB 406 can be used for storing the identification and rating data of each of the documents identified in the both the green list data field 402 and the red list data field 404, as well as documents whose rating is such that they belong to neither list (e.g., threshold for inclusion in the red list is larger than the threshold for inclusion into the green list). The MDB may also be used to generate the red and green lists on demand.

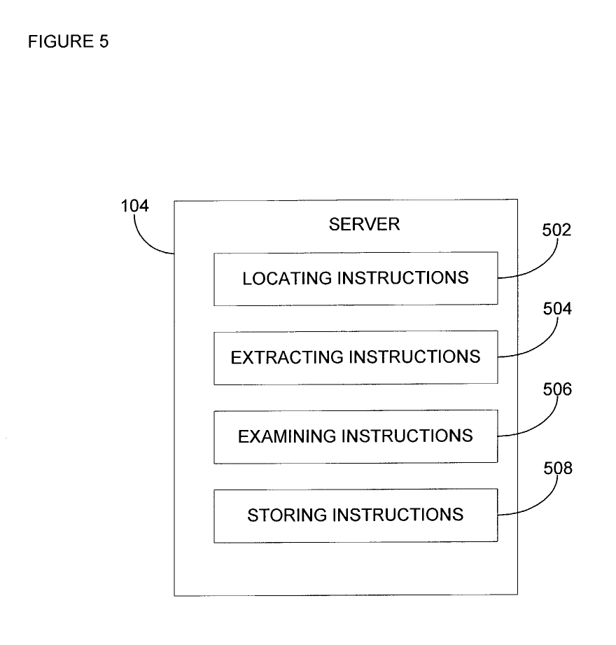

Referring now to FIG. 5, an exemplary block diagram illustrates components of a server 104 comprising computer executable instructions for categorizing a plurality of documents according to the invention. Locating instructions 502 include instructions for identifying the location of the plurality of documents to be evaluated. For example, locating instructions 502 identify the location of one or more web pages from one or more URLs specified by a user, or from one or more URLs contained in a memory (e.g., input data store). Locating instructions 502 further include instruction for automatically locating one or more documents based on extracted contextual features such as unknown links. (See extracting instructions 504).

Extracting instructions 504 include instructions for extracting textual and contextual features from the plurality of documents to be evaluated. For instance, extracting instructions 504 extract textual features such as words, letters, internal punctuation marks, and contextual features such as links, image text, and URLs. Extracting instructions 504 further include instructions for comparing target URL information in extracted links to URLs of documents previously categorized (e.g., URLs stored in output data store 110) to identify unknown links.

Examining instructions 506 include instructions for examining extracted textual and/or contextual features to determine whether the extracted textual and/or contextual features are trustworthy content. For example, examining instructions 506 employ statistical analysis (e.g., neural network) to examine text associated with images, text associated with links, text contained in the URL, or text associated with the web page in general to determine a rating for the web page. Examining instructions 506 compare the determined rating to a predefined threshold value to determine whether the extracted textual and/or contextual features are trustworthy content. For instance, if the determined rating is less than the predefined threshold value, examining instructions 506 designate the content as trustworthy. Alternatively, if the determined rating is greater than the predefined threshold value, examining instructions 506 designate the content as untrustworthy.

Storing instructions 508 include instructions for storing locations of categorized documents according to their categories. For example, storing instructions 508 store the URL of each web page having a determined rating less than or equal to a threshold value in a green list category, and store the URL of each web page having a determined score greater than the predetermined threshold value in a red list category.

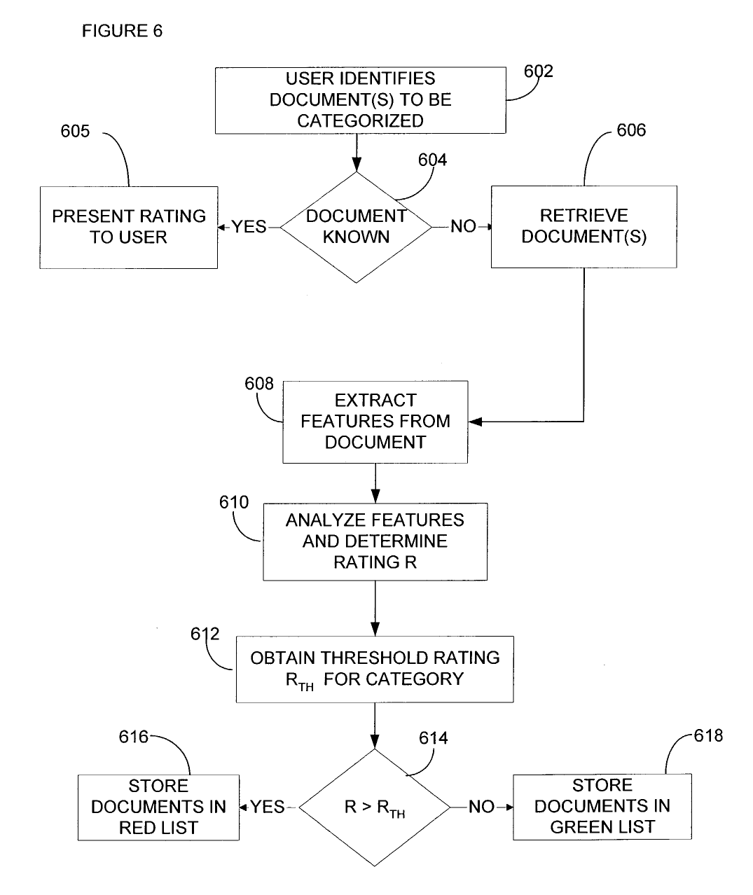

Referring next to FIG. 6, an exemplary flow chart illustrates a method of categorizing documents according to an exemplary embodiment described in reference to FIG. 1. The user 104 specifies a document or a list of documents such as web pages for classifying by inputting, for example, an URL or list of URLs identifying the location of web pages at 602. At 604 the URL of the web page is examined to determine whether or not the specified document was previously classified (i.e., known document) by comparing the URL of the web page with a list of URLs that correspond to previously classified web pages in the output data store 110. If the URL of the web page matches a URL that corresponds to a previously classified web page (i.e., equality of strings), the user 120 is presented the previous classification at 605. (“Matching” may be more complicated that equality of strings. For example, if “msn.com” is rated “not in category” and the input URL is “msn.com/foo”, and “msn.com/foo” doesn't have a stored rating of its own, then “msn.com/foo” will be rated “not in category.”). In this case, presenting the classification to the user 120 includes visually displaying the classification. In an alternate embodiment (not shown), the presenting includes filtering or blocking web pages from being displayed when the document is classified as something intended to be blocked (i.e., red list document). If the URL of the web page does not match any of the previously classified web pages, a server 120 retrieves the web page at 606. A feature extraction tool 108 extracts and/or analyzes features contained in the document at 608. As described above, such features include, but are not limited to, text, links, text associated with links, URL, and text associated with images. The extracted features are analyzed to determine a rating for the web page at 610. For example, text associated with images, text associated with links, text contained in the URL, or text associated with the web page in general can be analyzed using a neural network 302 as described above to calculate a rating for the web page. At 612 a predetermined threshold is retrieved from a database such as the MDB described above in reference to FIG. 4. The predetermined threshold defines a specific rating value, and can be used for assigning the web page to a particular category such as the green list or red list. At 614 the determined rating R is compared to a pre-determined threshold rating R_{TH}. In this example, if R is greater than or equal to R_{TH}, then the web page is assigned to the red list at 616. Alternatively, if R is less than R_{TH}, then the web page is assigned to the green list at 618.

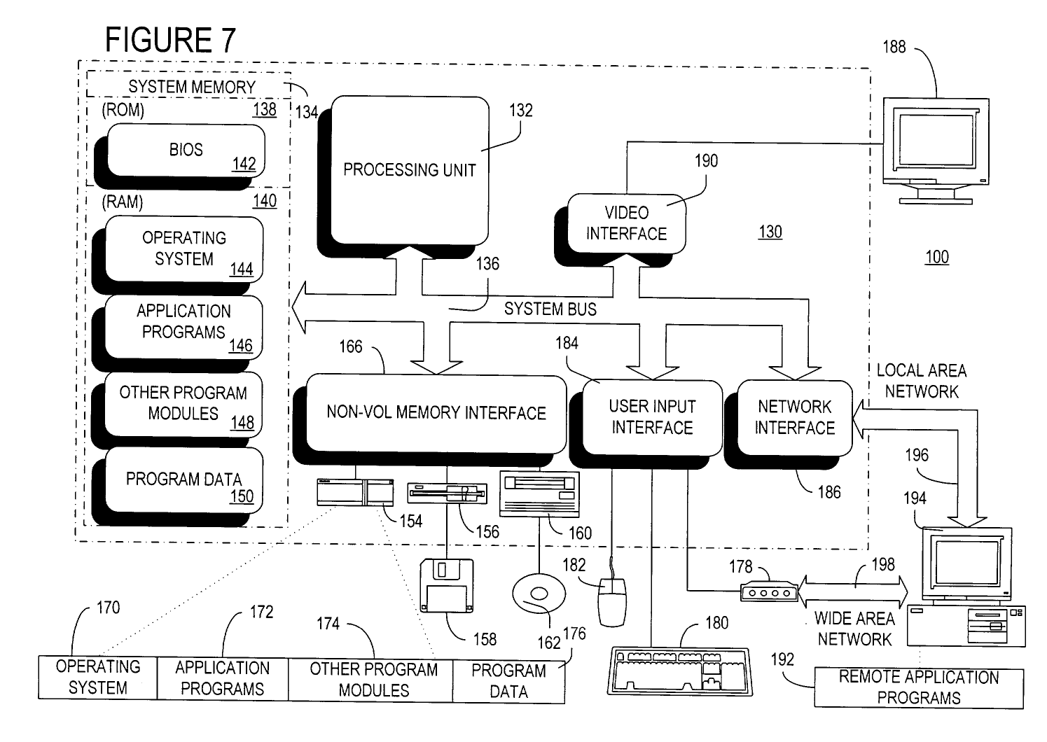

FIG. 7 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that can be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 7 illustrates operating system 144, application programs 146, other program modules 148, and program data 150.

The computer 130 may also include other removable/non-removable, volatile/nonvolatile computer storage media. For example, FIG. 7 illustrates a hard disk drive 154 that reads from or writes to non-removable, nonvolatile magnetic media. FIG. 7 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 7, provide storage of computer readable instructions, data structures, program modules and other data for the computer 130. In FIG. 7, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 7 include a local area network (LAN) 196 and a wide area network (WAN) 198, but may also include other networks. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 7 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above products and methods without departing from the scope of the invention, it is intended that all matter contained in the above description and shown in the accompanying drawings shall be interpreted as illustrative and not in a limiting sense.

What is claimed is:

1. A method of categorizing documents comprising:
locating a plurality of documents to be categorized;
extracting textual and contextual features from within each of the documents;
identifying untrustworthy documents from the extracted features, said untrustworthy documents being eliminated from the plurality of documents to be categorized;
evaluating each of the documents according to one or more of the extracted textual and contextual features;
identifying lists of documents from the evaluated documents relating to a topic in response to a user query relating to the topic; and
identifying documents within the identified lists relating to the topic.

2. The method of claim 1, wherein the plurality of documents are located by one or more of the following techniques:
considering documents identified by a user which have not been previously evaluated;
considering links within documents which links have not been previously evaluated; or
considering links within aggregated documents which links have not been previously evaluated.

3. The method of claim 1, wherein the evaluating each of the documents includes determining a rating for each of the documents as a function of the extracted textual and/or contextual features, wherein the identifying lists relative to the topic includes comparing the rating of each of the documents to a threshold value associated with the topic, said threshold value being predetermined by the user or a third party.

4. The method of claim 3, wherein a first list of documents includes documents having a determined rating less than or equal to the threshold value, and wherein a second list of documents includes documents having a determined rating greater than the threshold value.

5. The method of claim 3, wherein the extracting textual features from within each of the documents includes extracting textual components including words, letters, and internal punctuation marks, and wherein the evaluating each of the documents includes determining a rating for each of the documents as a function of the extracted textual components.

6. The method of claim 3, wherein the extracting contextual features from within each of the documents includes extracting text associated with an image within the document, and wherein the evaluating each of the documents includes determining the rating for each of the documents as a function of the extracted text associated with the image.

7. The method of claim 3, wherein the extracting contextual features from within each of the documents includes extracting text associated with a link within the document, and wherein the evaluating each of the documents includes determining the rating for each of the documents as a function of the extracted text associated with the link.

8. The method of claim 1, wherein the extracting contextual features from within each of the documents includes extracting links from within each of the documents, wherein the evaluating each of the documents includes comparing target locations of extracted links to locations of the identified list of documents to identify unknown links, and wherein target documents of one or more of said unknown links are automatically located to be categorized.

9. The method of claim 1, wherein the extracting contextual features from within each of the documents includes extracting a file name (e.g., URL) of each of the documents, and wherein the evaluating each of the documents includes comparing the extracted file name for each of the documents to file names of the identified list of documents to determine whether a particular document has been previously evaluated.

10. A method of categorizing documents comprising:
locating a plurality of documents to be categorized;
evaluating each of the located plurality of documents according one or more of the following:
eliminating pathological pages;
rating connected documents;
analyzing links within each of the documents;
analyzing a file name (e.g., URL) of each of the documents; and
analyzing names of images within each of the documents;
indexing the evaluated documents into a plurality of lists in response to a user query relating to a topic; and
identifying lists relating to the topic and identifying documents within the identified lists relating to the topic.

11. A method of categorizing documents comprising:
locating a plurality of documents to be categorized according to one or more of the following:
considering documents identified by a user which have not been previously evaluated;
considering links within documents which links have not been previously evaluated; and
considering links within aggregated documents which links have not been previously evaluated;
evaluating each of the located plurality of documents;
indexing the evaluated documents into a plurality of lists in response to a user query relating to a topic; and
identifying lists relating to the topic and identifying documents within the identified lists relating to the topic.

12. A system of categorizing documents comprising:
an input data store identifying documents to be evaluated;
a feature extraction tool extracting page-level information and features from the documents to be evaluated;
a committee machine:
for consolidating extracted page-level information and features to decide whether the extracted page-level information and features are trustworthy content;
for categorizing the documents based on whether the extracted page-level level information and features are trustworthy content;
an output data store for storing an identification of each of the categorized documents according to their categories.

13. The system of claim 12, wherein the committee machine is a learning-based classifier, and wherein the learning-based classifier determines a rating of each of the documents according to extracted page-level information and features.

14. The system of claim 13, wherein the committee machine categorizes documents into a first list of documents and a second list of documents by comparing the determined rating of each document to a threshold value, said threshold value being defined by a user or a third party, and wherein the first list of documents includes documents having a determined rating less than or equal to the threshold value, and wherein the second list of documents includes documents having a determined rating greater than the threshold value.

15. The system of claim 14, wherein the output data store is a master database storing the identification of the first list of documents and the identification of the second list of documents.

16. The system of claim 15, wherein the output data store further stores the rating of each the categorized documents and the threshold value.

17. The system of claim 15 further including a training data store for storing training documents, wherein said training documents are used to train the committee machine.

18. A computer readable medium having computer executable instructions for categorizing a plurality of documents, comprising:
locating instructions for locating the plurality of documents to be evaluated;
extracting instructions for extracting page-level information and/or features from the documents to be evaluated;
examining instructions for examining the extracted page-level information and/or features to determine whether the extracted page-level information and/or features are trustworthy content;
categorizing instruction for categorizing documents according to extracted identified page-level level information and/or features determined to be trustworthy content; and
storing instructions for storing locations of categorized documents according to their categories.

19. The computer readable medium of claim 18, wherein the locating instructions includes instruction for locating one or more documents in response to a request received from a user.

20. The computer readable medium of claim 19, wherein the categorizing instructions includes instructions for determining a rating for each of the located documents as a function of the extracted features.

21. The computer readable medium of claim 20, wherein the examining instructions includes instruction for examining textual components from within each of the located documents, said textual components include words, letters, and internal punctuation marks, and wherein the categorizing instructions includes instructions for determining the rating for each of the located documents as a function of the extracted textual components.

22. The computer readable medium of claim 21, wherein the examining instructions includes instruction for examining contextual components from within each of the located documents, said contextual components include links, text associated with links, text associated with images, and URLs, and wherein the categorizing instructions includes instructions for determining the rating for each of the documents as a function of the examined contextual components.

23. The computer readable medium of claim 22, wherein the storing instructions includes instructions for storing documents having a determined rating less than or equal to a threshold value in a first list, and wherein the storing instructions includes instructions for storing documents having a determined score greater than the predetermined threshold value in a second list, said threshold value being predetermined by a user or third party.

24. The computer readable medium of claim 18, wherein the examining instructions includes instructions for identifying untrustworthy documents as a function of the extracted features, and wherein the examining instructions includes instruction for eliminating identified untrustworthy documents from categorization.

25. The computer readable medium of claim 18, wherein the extracting instructions includes instruction for extracting links from within each of the documents, wherein the examining instructions includes instruction for determining a location of a target document of the link, and wherein the examining instructions includes instructions for comparing the determined location of the target document to stored locations of categorized documents to identify unknown links.

26. The computer readable medium of claim 25, wherein the locating instructions further includes instruction for automatically locating one or more documents identified by unknown links.
